(19) United States
(12) Patent Application Publication
(10) Pub. No.: US 2009/0225338 A1
(43) Pub. Date: Sep. 10, 2009

(54) IMAGE PRINTING DEVICE AND METHOD FOR CONTROLLING IMAGE PRINTING DEVICE

(75) Inventor: Yoshinao Kitahara, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/365,367

(22) Filed: Feb. 4, 2009

(30) Foreign Application Priority Data
Feb. 4, 2008 (JP) 2008-024039

(51) Int. Cl. H04N 1/60

(52) U.S. Cl. 358/1.9

(57) ABSTRACT

An image printing device configured to be directly connected to an image recording device into and from which a recording medium may be loaded and removed, respectively, and to print an image represented by a plurality of image data to be printed recorded on the recording medium, is provided. The image printing device includes a display unit, a buffer memory, a printing unit, a printer control unit and a user interface.

This application claims priority to Japanese Patent Application No. 2008-024039, filed Feb. 4, 2008. The entire disclosure of which is expressly incorporated by reference herein.

### BACKGROUND

1. Technical Field

The present invention relates to a direct print technology in which an image recording device such as a digital still camera (DSC) or a digital video camera (DVC) is directly connected to an image printing device, i.e., a printer. The DVC or DSC is provided with a recording/reproducing device such as a digital versatile disk (DVD) drive or a compact disk (CD) drive. An image recorded on a recording medium such as a DVD or a CD loaded into the recording/reproducing device may be directly printed without a computer such as a personal computer by using the direct print technology.

2. Related Art

Image data of an image photographed by a DSC or a DVC may once be transferred to a personal computer (hereinafter called PC) and an image represented by the image data transferred to the PC may be printed by a printer. Different from the above, in a direct print operation, the image data are directly transferred from the DVC or DSC to the printer so as to print the image represented by the transferred image data. As a method for direct printing, a CIPA (Camera & Imaging Products Association) standard DC-001-2003 (hereinafter called “PictBridge”) has been proposed as disclosed in White Paper of CIPA DC-001-2003 Rev. 2.0 Digital Photo Solutions for Imaging Devices ([online]. Camera & Imaging Products Association, Apr. 25, 2007. [retrieved on 2007-11-29]. Retrieved from the Internet: <URL:http://www.cipa.jp/pictbridge/documents_j/WhitePaperJ_R ev.2.0.pdf>).

JP A-2005-20107 is an example of the related art.

For example, a DVC having a direct print function according to the above PictBridge standard is connected to a printer so as to form a direct print system. It may be desired that an image represented by image data recorded on a DVD loaded into a DVD drive provided to the DVC is printed on the DVD itself as a label.

In this case, however, as the image data to be printed is recorded on the DVD being a print medium on which the label is to be printed, the DVD being the print medium is also a recording medium. Thus, the DVD being the recording medium has to remain loaded into the DVD drive of the DVC until the image data to be printed are transferred to the printer and the print operation is completed. Meanwhile, the DVD has to be set in the printer as the print medium so that the label may be printed on the DVD being the print medium.

Thus, it is difficult to simply print the image recorded on the DVD being the recording medium on the DVD also being the print medium by using a usual method for direct printing.

The above difficulty is not only a problem in printing the image recorded on the DVD being the recording medium on the DVD being the print medium, but also a common problem in printing an image recorded on a recording medium of an image recording device directly connected to an image printing device on the recording medium also being a print medium.

### SUMMARY

An advantage of some aspects of the invention is that it addresses the problem of the usual method for direct printing described above, so that an image printing device directly connected to an image recording device so as to print an image to be printed may print the image on a recording medium on which the image to be printed is recorded.

Another advantage of some aspects of the invention is to at least partially address the above problem. The invention may be implemented as following embodiments or application examples.

### First Application

An image printing device configured to be directly connected to an image recording device into and from which a recording medium may be loaded and removed, respectively, the image printing device configured to print an image represented by a plurality of image data to be printed recorded on the recording medium, including:

a display unit;

a buffer memory;

a printing unit;

a print control unit configured to request the image recording device to send the image data to be printed upon being requested to start a print job by the image recording device, the print control unit configured to obtain and store in the buffer memory all the image data to be printed sent from the image recording device if provided with a specific setting with respect to a print medium before being requested to start the print job by the image recording device, the print control unit configured to make the printing unit print the image represented by the image data to be printed; and

a user interface configured to display an allowed recording medium ejection screen on the display unit after all the image data to be printed are obtained, so as to enable the print control unit after displaying the allowed recording medium ejection screen to make the print unit start to print the image on the recording medium loaded into the image printing device as the print device by using the image data to be printed stored in the buffer memory.

The image printing device of the first application may print an image on a recording medium on which the image to be printed is recorded.

“To be directly connected to an image recording device” means that the image recording device and the image printing device may directly communicate with each other in accordance with a wired or wireless communication standard without being relayed by a device such as a computer.

### Second Application

The image printing device according to the first application, wherein the specific setting is to specify a kind of the print medium notified by the image recording device.

The image printing device of the second application may print an image on a recording medium on which the image to be printed is recorded, in a case where a specific print medium has been set as a kind of the print medium.

### Third Application

The image printing device according to the first application, wherein the specific setting is to specify the recording medium loaded into the image recording device as the print medium beforehand through the user interface.

The image printing device of the third application may print an image on a recording medium on which the image to be printed is recorded, in a case where the recording medium loaded into the image recording device has been set as the print medium beforehand through the user interface.

### Fourth Application

The image printing device according to the first application, wherein the specific setting is to specify the recording medium loaded into the image recording device as the print medium beforehand through the user interface, and to specify a kind of the print medium notified by the image recording device.

The image printing device of the fourth application may print an image on a recording medium on which the image to be printed is recorded, in a case where the recording medium loaded into the image recording device has been set as the print medium beforehand through the user interface, and a specific print medium has been set as a kind of the print medium.

### Fifth Application

The image printing device according to the first to fourth applications, wherein the print control unit is configured to display a screen for encouraging a user to direct the user interface to start to obtain the image data to be printed on the basis of the specific setting after being requested to start the print job, the print control unit configured to request the image recording device to send the image data to be printed upon the user directing to start to obtain the image data.

The image printing device of the fifth application may start to obtain the image data to be printed on the basis of the direction of the user.

The invention may be implemented as various embodiments, such as an image printing device, a method for controlling an image printing device, a method for printing an image, a computer program for implementing functions of those methods or devices, a recording medium on which the computer program is recorded, a data signal including the computer program and carried by a carrier wave, and so on.

### BRIEF DESCRIPTION OF THE DRAWINGS

The invention will be described with reference to the accompanying drawings, wherein like numbers reference like elements.

FIG. 1 illustrates a generic configuration of a direct print system to which an image printing device of an embodiment of the invention is applied.

FIG. 2 illustrates a process for printing a label by means of direct printing.

FIG. 3 illustrates a process for printing a label by means of direct printing.

FIG. 4 illustrates a set up screen for direct printing.

FIGS. 5 shows an example of a getting ready for printing screen.

FIG. 6 shows an example of a now printing screen.

FIG. 7 shows an example of an allowed recording medium ejection screen.

### DESCRIPTION OF EXEMPLARY EMBODIMENTS

An embodiment of the invention will be described in following sections in order.

### A. Direct Print System

### B. Label Printing Operation

### C. Modifications

### A. Direct Print System

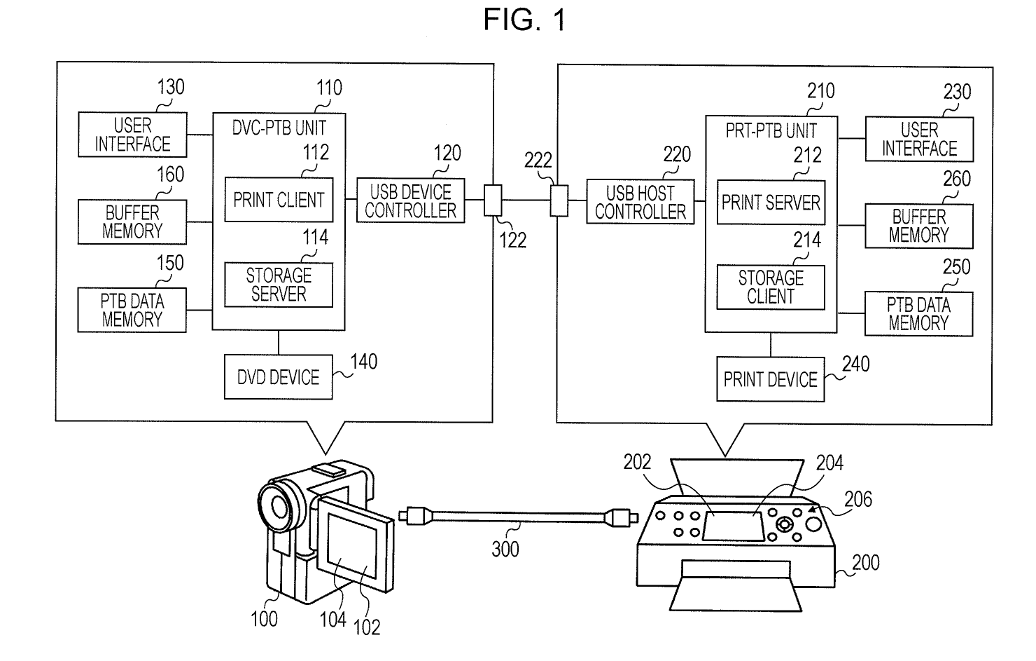

FIG. 1 illustrates a generic configuration of a direct print system to which an image printing device of the embodiment of the invention is applied. The direct print system is constituted by a DVC 100 being an image recording device and a printer 200 being an image printing device which are connected to each other through a USB cable 300.

The DVC 100 has a display panel 102 configured to display various screens, and a touch panel 104 as a user input interface. Although not shown, the DVC 100 may have an operation unit including various operation keys as another user input interface. The DVC 100 has a DVC-PTB unit 110, a USB device controller 120, a user interface 130, a DVD device (DVD drive) 140, a PTB data memory 150 and a buffer memory 160 as functional blocks for direct printing in accordance with the PictBridge standard.

The printer 200 has, similarly to the DVC 100, a display panel 202 configured to display various screens, a touch panel 204 as a user input interface and an operation unit 206 including various operation keys. The printer 200 has, similarly to the DVC 100, a PRT-PTB unit 210, a USB host controller 220, a user interface 230, a print device 240, a PTB data memory 250 and a buffer memory 260 as functional blocks for direct printing in accordance with the PictBridge standard. The display panel 202, the PRT-PTB unit 210 and the print device 240 correspond to a display unit, a print control unit and a printing unit, respectively.

The USB device controller 120 of the DVC 100 and the USB host controller 220 of the printer 200 are connected to each other through a USB connector 122 and the USB cable 300 of the DVC 100, and a USB connector 222 of the printer 200. The USB device controller 120 and the USB host controller 220 may perform communication with each other in accordance with the USB (Universal Serial Bus) standard.

The DVC-PTB unit 110 of the DVC 100 and the PRT-PTB unit 210 of the printer 200 are connected to each other through the USB controller 120 and the connector 122 of the DVC 100, and the connector 222 and the USB host controller 220 of the printer 200. The DVC-PTB unit 110 and the PRT-PTB unit 210 may perform communication with each other in accordance with the PictBridge standard so that image data to be printed are transferred from the DVC 100 to the printer 200 and are directly printed. That is, for direct printing in accordance with the PictBridge standard, the DVC-PTB unit 110 controls the DVC 100 so that the DVC 100 operates in accordance with the PictBridge standard, and the PRT-PTB unit 210 controls the printer 200 so that the printer 200 operates in accordance with the PictBridge standard.

The DVC-PTB unit 110 is configured to function mainly as a print client 112 and a storage server 114. The PRT-PTB unit 210 is configured to function mainly as a print server 212 and a storage client 214. The print client 112 is configured to request the print server 212 to print an image to be printed. The storage server 114 is configured to send the image data to be printed in response to a request from the storage client 214 of the PRT-PTB unit 210. The print server 212 is configured to perform direct printing in response to the request from the print client 112 of the DVC-PTB unit 110. The storage client 214 is configured to request the storage server 114 to send the image data to be printed.

The user interface 130 of the DVC 100 is configured to perform a control operation for displaying a screen in accordance with an operation of the DVC 100 on the display panel 102, and to control an input operation of a user through the touch panel 104 and the operation unit.

The DVD device 140 is a recording/reproducing device configured to record image data on a DVD being a recording medium loaded into a drive that is not shown, and to read the image data recorded on the loaded DVD being the recording medium.

The PTB data memory 150 of the DVC 100 is a memory configured to store a command for supporting the DVC-PTB unit 110 in accordance with the PictBridge standard, and to store data of operation conditions. The buffer memory 160 is a memory configured to temporarily store various data such as the image data read by the DVD device 140.

The user interface 230 of the printer 200 is configured to control a screen displayed on the display panel 202 in accordance with the operation of the printer 200, and to control input operations of the user through the touch panel 204 and the operation unit 206.

The print device 240 is configured to actually perform printing.

The PTB data memory 250 of the printer 200 is configured to store a command for supporting the PRT-PTB unit 210 in accordance with the PictBridge standard, and to store data of operation conditions. The buffer memory 260 is configured to temporarily store various data such as the image data to be printed sent from the DVC 100.

The DVC-PTB unit 110 of the DVC 100 and the PRT-PTB unit 210 of the printer 200 may communicate with each other in accordance with the PictBridge standard as described above, so that the image data recorded on the DVD being a recording medium loaded into the DVD device 140 of the DVC 100 may be transferred from the DVC 100 to the printer 200, and the image data to be printed may be directly printed. The invention has a feature that the PRT-PTB unit 210 of the printer 200 being an image printing device is configured to operate as described later so that a label may be printed on the DVD being a print medium as well as a recording medium on which the image data to be printed is recorded. Thus, a label printing operation will be explained hereafter.

### B. Label Printing Operation

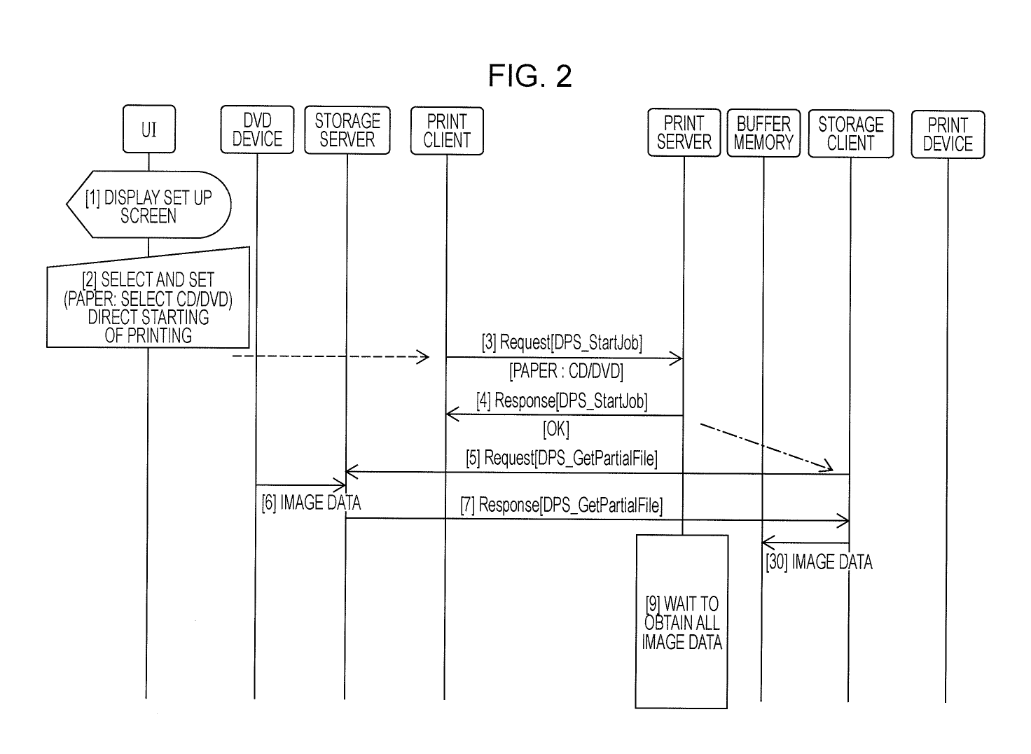

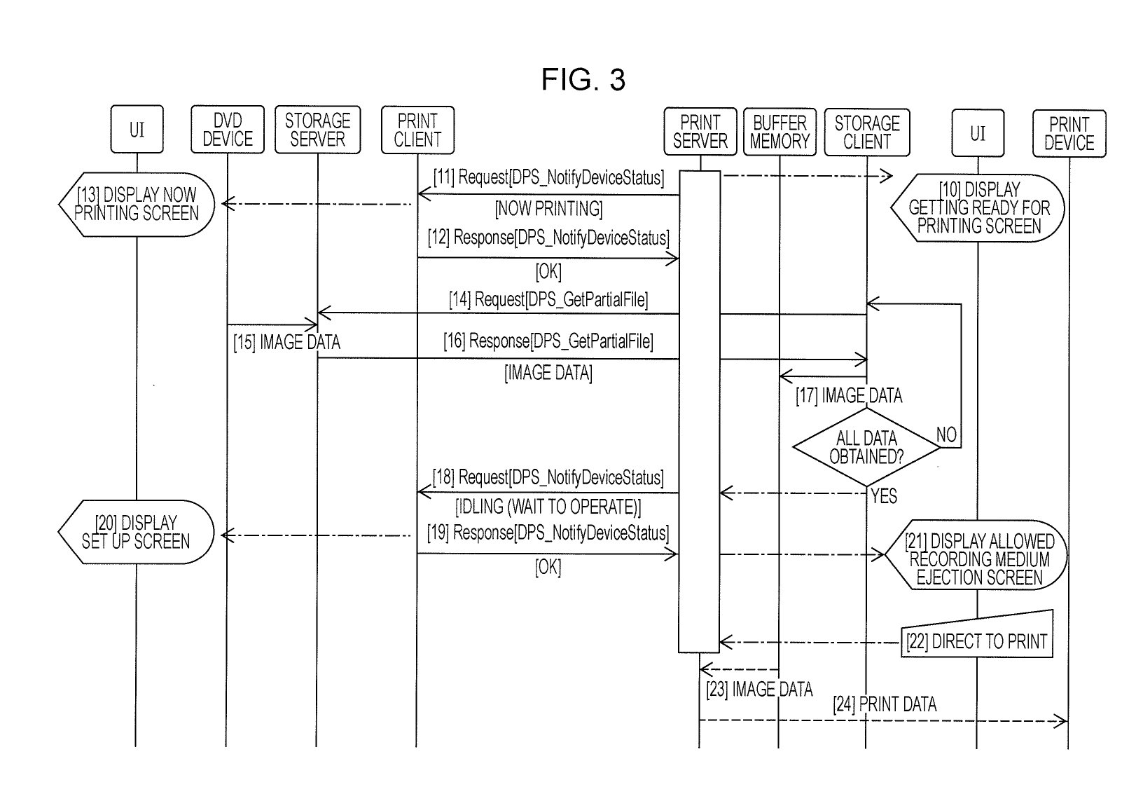

FIGS. 2-3 illustrates a process for printing a label by means of direct printing. The operation described below may be started on condition that the USB cable 300 is connected to the connector 122 of the DVC 100 and the connector 222 of the printer 200 so that the USB device controller 120 of the DVC 100 and the USB host controller 220 of the printer 200 may perform various processes after detecting the above connection so as to be ready for the communication according to the PictBridge standard. It is assumed that the DVC-PTB unit 110 of the DVC 100 and the PRT-PTB unit 210 of the printer 200 have performed ordinary preparatory processes such as a negotiation process with respect to whether both of the devices correspond to the PictBridge standard, a negotiation process of services which both of the devices correspond to and so on after being triggered by the above detection.

At first at step [1], the user interface (UI) 130 of the DVC 100 displays on the display panel 102 a set up screen 400 for direct printing as a user interface screen.

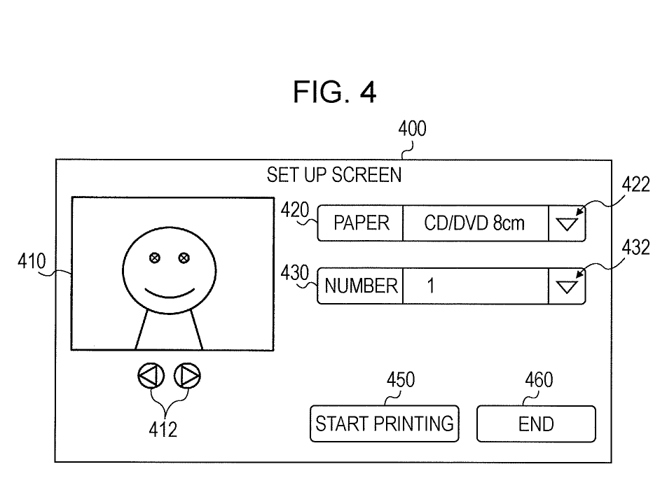

FIG. 4 illustrates the set up screen 400 for direct printing. The set up screen 400 includes a preview area 410 of the image to be printed, an image to be printed select button 412, a paper (print medium) select area 420, a number of copies select area 430, a print start button 450 and an end button 460.

The user may properly press select tabs 422 and 432 of the select areas 420 and 430 of the set up screen 400, respectively, so as to select and set a preferred paper type and the number of copies. The user may press the image to be printed select button 412 so as to select and set the image to be printed while viewing an image displayed on the preview area 410. The user may press the print start button 450 so as to start a process for direct printing. FIG. 4 shows a case as an example where “CD/DVD of 8 cm” is selected as the paper, and the number of copies is set to “1”.

If the user presses the print start button 450 and directs starting of printing, the print client 112 of the DVC-PTB unit 110 of the DVC 100 starts the process for direct printing.

At first at step [3], the print client 112 provides the print server 212 of the PRT-PTB unit 210 of the printer 200 with a request message using an action “DPS_StartJob” defined in the PictBridge standard so as to request the print server 212 to start a print job. Although not shown, the request message includes various kinds of information such as the paper (print medium), the number of copies, information for specifying the image to be printed and so on.

If printing by the print device 240 is available, the print server 212 having received the request for starting the print job provides the print client 112 of the DVC 100 at step [4] with a response message including information that printing is available (shown by “OK” in FIG. 2).

Then, at step [5], the storage client 214 of the PRT-PTB unit 210 provides the storage server 114 of the DVC-PTB unit 110 with a request message using an action “DPS_GetPartialFile” defined in the PictBridge standard so as to request the storage server 114 to obtain the image data to be printed divided into plural parts part by part.

At this moment, at step [6], the storage server 114 reads a part of the image data to be printed from the DVD being a recording medium loaded into the DVD device 140, and temporarily stores the above part of the image data in the buffer memory 160. At step [7], the storage server 114 provides the storage client 214 with a response message including the above part of the image data to be printed temporarily stored in the buffer memory 160.

At step [8], the storage client 214 stores the part of the image data to be printed received from the storage server 114 in the buffer memory 260.

The print server 212 would start printing on the basis of the image data to be printed stored in the buffer memory 260 by using the print device 240 in accordance with a usual process for direct printing. As described above, however, in a case where a recording medium on which printing is available such as the DVD, i.e., the recording medium of the DVC 100 is set to be the paper (print medium), e.g., “CD/DVD of 8 cm”, the print server 212 pauses before starting the print operation at step [9]. The print server 212 then waits for all the image data to be obtained.

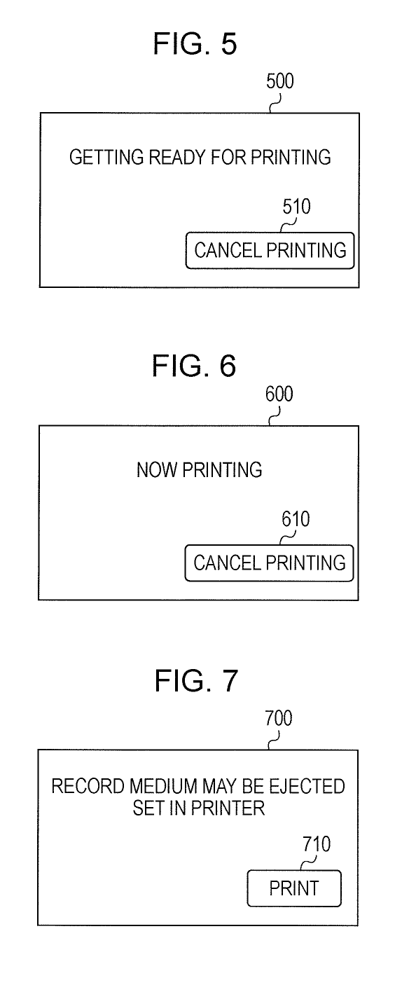

At this moment, at step [10], the user interface 230 of the printer 200 displays on the display panel 202 a screen 500 for notifying the user that the printer 200 is getting ready for printing (getting ready for printing screen) as shown in FIG. 5.

At step [11], the print server 212 provides the print client 112 with a request message using an action “DPS_NotifyDeviceStatus” defined in the PictBridge standard so as to notify the print client 112 that the printer 200 is “now printing”. Printing is not actually performed, though. The action “DPS_NotifyDeviceStatus” is an action for notifying the print client 112 of a status change of the print device 240.

Having received the above notification of “now printing”, the print client 112 provides the print server 212, at step [12], with a response message (“OK”) saying that the notification has been received. At this moment, at step [13], the user interface 130 of the DVC 100 displays on the display panel 102 a screen 600 for notifying the user that the printer 200 is now printing (now printing screen) as shown in FIG. 6.

Further, at step [14], the storage client 214 provides the storage server 114 with a request message using an action “DPS_GetPartialFile” defined in the PictBridge standard so as to request the storage server 114 to obtain the image data to be printed part by part.

At this moment, at step [15], the storage server 114 reads the image data to be printed from the DVD loaded into the DVD device 140 in order, and temporarily stores the image data in the buffer memory 160. At step [16], the storage server 114 provides the storage client 214 with a response message including the above image data to be printed temporarily stored part by part in the buffer memory 160.

At step [17], the storage client 214 stores the image data to be printed received from the storage server 114 part by part in the buffer memory 260.

Then, the above processes [14]-[17] are repeated between the storage client 214 and the storage server 114 until the storage client 214 obtains all the image data to be printed.

Having obtained all the image data to be printed, the print server 212 provides the print client 112 at step [18] with a request message using the action “DPS_NotifyDeviceStatus” so as to notify the print client 112 that the print device 240 is available for printing and is idling (waiting for operation).

Having received the notification of step [18], the print client 112 provides the print server 212 at step [19] with a response message (“OK”) saying that the notification has been received, and then ends the process for direct printing. At this moment, at step [20], the user interface 130 displays on the display panel 102 the set up screen 400 for direct printing as a user interface screen similarly as at step [1].

If the print server 212 receives the notification of step [19], the user interface 230 displays a screen 700 for prompting the user to eject the recording medium and set the recording medium in the printer (screen allowing recording medium ejection) at step [21]. At this moment, the user may eject the DVD (recording medium) loaded into the DVD device 140 and set the DVD in the printer 200 as the print medium.

If the user presses the print button 710 shown in FIG. 7 so as to direct performance of printing at step [22], the print server 212 resumes the print job. At step [23], the print server 212 reads the image data to be printed stored in the buffer memory 260. At step [24], the print server 212 provides the print device 240 with the above image data to be printed read from the buffer memory 260 as the print data.

Having received the print data, the print device 240 prints the image represented by the image data to be printed received as the print data on the DVD set as the print medium.

As described above, in the case where the recording medium on which printing is available such as the DVD, i.e., the recording medium of the DVC 100 is set to be the paper (print medium), e.g., “CD/DVD of 8 cm”, the printer 200 pauses before starting the print operation. The printer 200 then stores all the image data to be printed sent from the DVC 100 in the buffer memory 260 so that the DVD being the recording medium as well as the print medium may be ejected from the DVD device 140 and may be set in the printer 200 as the print medium. Thus, the label may be printed on the DVD being the print medium, on which being the recording medium the image data to be printed is recorded. A DVC for performing the usual direct printing operation may be connected to the printer 200 of the embodiment, so that a label represented by image data recorded on a recording medium loaded into the DVC may be printed on the recording medium being a print medium.

### C. Modifications

The invention is not limited to the above example and the embodiment described above, and may be implemented in various forms within the scope of the invention.

As described with respect to the above embodiment, in a case where a recording medium on which printing is available such as the DVD, i.e., the recording medium of the DVC 100 is set to be the paper (print medium), e.g., “CD/DVD of 8 cm”, the printer of the above embodiment pauses before starting the print operation, and stores all the image data to be printed sent from the DVC 100 in the buffer memory 260. In a case where the user selects the recording medium loaded into the DVC to be set as the print medium beforehand, the printer 200 is not limited to the above, and may be configured to pause before starting the print operation regardless of setting of the paper (print medium), and to store all the image data to be printed sent from the DVC 100 in the buffer memory 260. In a case where the user selects the recording medium loaded into the DVC to be set as the print medium and selects the recording medium itself on which printing is available to be the paper (print medium), the printer 200 may be configured to pause before starting the print operation regardless of setting of the paper (print medium), and to store all the image data to be printed sent from the DVC 100 in the buffer memory 260.

As described with respect to the above embodiment, the user presses the print button 710 shown in FIG. 7 so that the printer 200 performs printing by using the image data to be printed stored in the buffer memory 260. The printer 200 is not limited to the above, and may be configured to perform printing on the basis that the recording medium is set as the print medium.

As described with respect to the above embodiment, the image recording device configured to be connected to the image printing device, the printer, is the DVC. The image recording device is not limited to the above, and may be an image recording device such as a DVD recorder that may be loaded with a DVD.

As described with respect to the above embodiment, the recording medium to be used as the print medium is a usual DVD. The recording medium to be used as the print medium is not limited to the above, and may be one of various removable and portable record media such as a BD (Blue-ray Disk) or a HD-DVD. That is, the invention may be applied to a medium on which image data to be printed may be recorded and printing is available, and to an image recording device into which the medium is loaded as a recording medium.

As described with respect to the above embodiment, the DVC 100 and the printer 200 are connected through the USB cable 300 and perform communication in accordance with the USB standard. The invention may also be applied to cases where communication may be performed in accordance with various standards regardless of whether through wired or wireless connections.

As described with respect to the above embodiment, the invention is applied to the print system adapted for direct printing according to the PictBridge standard. The invention is not limited to the above, and may be applied to a print system adapted for direct printing according to another standard for direct printing.

What is claimed is:

1. An image printing device configured to be directly connected to an image recording device into and from which a recording medium may be loaded and removed, respectively, the image printing device configured to print an image represented by a plurality of image data to be printed recorded on the recording medium, comprising:
a display unit;
a buffer memory;
a printing unit;
a print control unit configured to request the image recording device to send the image data to be printed upon being requested to start a print job by the image recording device, the print control unit configured to obtain and store in the buffer memory all the image data to be printed sent from the image recording device if provided with a specific setting with respect to a print medium before being requested to start the print job by the image recording device, the print control unit configured to make the printing unit print the image represented by the image data to be printed; and
a user interface configured to display an allowed recording medium ejection screen on the display unit after all the image data to be printed are obtained, so as to enable the print control unit after displaying the allowed recording medium ejection screen to make the print unit start to print the image on the recording medium loaded into the image printing device as the print device by using the image data to be printed stored in the buffer memory.

2. The image printing device according to claim 1, wherein the specific setting is to specify a kind of the print medium notified by the image recording device.

3. The image printing device according to claim 1, wherein the specific setting is to specify the recording medium loaded into the image recording device as the print medium beforehand through the user interface.

4. The image printing device according to claim 1, wherein the specific setting is to specify the recording medium loaded into the image recording device as the print medium beforehand through the user interface, and to specify a kind of the print medium notified by the image recording device.

5. The image printing device according to claim 1, wherein the print control unit is configured to display a screen for prompting a user to direct the user interface to start to obtain the image data to be printed on the basis of the specific setting after being requested to start the print job, the print control unit configured to request the image recording device to send the image data to be printed upon the user directing to start to obtain the image data.

6. A method for controlling an image printing device configured to be directly connected to an image recording device into and from which a recording medium may be loaded and removed, respectively, the image printing device configured to print an image represented by a plurality of image data to be printed recorded on the recording medium, comprising:
obtaining and storing in a buffer memory of the image printing device all the image data to be printed sent from the image recording device if provided with a specific setting with respect to a print medium, upon being requested to start a print job by the image recording device;
displaying an allowed recording medium ejection screen on a display unit of the image printing device after obtaining all the image data to be printed; and
making a print unit of the image printing device start to print the image on the recording medium loaded into the image printing device as the print device by using the image data to be printed stored in the buffer memory.
